(19) United States
(12) Patent Application Publication
(10) Pub. No.: US 2003/0152485 A1
(43) Pub. Date: Aug. 14, 2003

(54) Flow cell system

(76) Inventors: Hans-Heinrich Trutnau, Braunfels (DE); Mark Siemer, Eugene, OR (US)

Correspondence Address: George L. Snyder, Jr., Hodgson Russ LLP, One M&T Plaza, Suite 2000, Buffalo, NY, 14203-2391, US

(21) Appl. No.: 10/074,649

(22) Filed: Feb. 13, 2002

(51) Int. Cl. G01N 1/20

(52) U.S. Cl. 422/81; 422/82.05; 422/82.08; 422/82.09; 422/99; 422/103

(57) ABSTRACT

A flow cell comprises a flow cell head which partly surrounds an inner pipe defining a supply pipe and an outer pipe defining a discharge pipe. The inner pipe defines an end portion, the outer pipe defines an end portion and the inner and the outer pipe are arranged concentrically in the area of their end portions. The end portion of the outer pipe is hold by a press fit in the flow cell head.

### FIELD OF THE INVENTION

The invention refers to a flow cell system. Moreover the invention refers to a flow cell system which is designed in a way that it provides a constant flow across the sensor surface.

### BACKGROUND OF THE INVENTION

The Japanese Patent Application, publication number 11183372 shows an SPR (Surface Plasmon Resonance) sensor device having a small size and high detection accuracy. The fluid supply system is firmly crimped to the surface of the prism by bolts and nuts. The fluid supply system comprises a feed pipe, which is made sufficiently long to provide a laminar flow. A fluid discharge pipe surrounds the fluid feed pipe and the fluid feed pipe is mounted in the centre of the fluid discharge pipe. The fluid supply system is mounted at a slight gap from the detection surface of the SPR sensor. In addition to that, ring-like electrodes are fitted to the feed pipe and the discharge pipe as electrochemical sensors.

A further Japanese Patent Application, publication number 2000171391 shows SPR sensor cell and immune reaction measuring device. The SPR sensor cell includes a hollow cylindrical specimen cell for storing a designated specimen, a first cover member and a second cover member for sealing the opening of the specimen cell, and a sensor optical fiber mounted on one of the cover members where one end face of the sensor optical fiber is exposed to the outside. A SPR sensor part is formed in the other end area of the sensor optical fiber and the SPR sensor part is dipped in the specimen.

The European Patent Application EP 0 971 226 shows a SPR sensor cell and immunoassay apparatus using the same. The SPR sensor cell comprises: a light-transparent core; a clad covering the core and having a through hole at a predetermined position to communicate with the core; and a predetermined thin metal film formed on an exposed surface of the core corresponding to the through hole. The clad can be configured in one embodiment with a fixing hole formed in one comer of the through hole. The tip fixing hole is used for inserting a tip and pouring or sucking a sample. The tip is attached to the tip of a pipette.

The PCT application WO 01/69209 discloses a two-dimensional imaging surface plasmon resonance (SPR) apparatus for optical surface analysis of a sample area on a sensor surface. The apparatus comprises a sensor surface layer of a conductive material that can support a surface plasmon, such as a free electron metal, e.g., gold, silver or aluminium. The apparatus is suitable for use in biological, biochemical, chemical and physical testing. To the prism, which carries the sensor surface, a flow cell can be attached. In order to avoid leakage, a seal can be inserted between the prism and the flow cell. The flow cell can be fitted to a flow system which may comprise a conduit system and a pump to transport the fluid trough the flow cell.

### SUMMARY OF THE INVENTION

It is the object of the invention to provide a flow cell system which can be used for SPR-measurements and can be easily attached or removed from the sensor surface.

The above object is solved by a flow cell system, which comprises:

an inner pipe defining a supply pipe with an end portion;

an outer pipe surrounding the inner pipe at a selected distance and defining a discharge pipe with an end portion;

a flow cell head being attached to a sensor surface and

a tip defined by the end portion of the inner pipe and the outer pipe, wherein the tip is arranged adjacent to the sensor surface, and the tip and the flow cell head are hold together by a press fit.

It is a further object of the invention to provide a flow cell, which can be easily handled and allows a wide variety of applications.

The above object is solved by a flow cell which comprises:

a flow cell head;

an inner pipe defining a supply pipe; and

an outer pipe defining a discharge pipe, wherein the inner pipe defines an end portion, the outer pipe defines an end portion and the inner and the outer pipe are arranged concentrically in the area of their end portions, and the end portion of the outer pipe is hold by a press fit in the flow cell head.

It is advantageous that the flow cell system or the flow cell is not mounted to sensor surface with bolts or the like. This enables an easy way to remove the flow cell system from the sensor surface. In case that the flow cell head remains attached to the sensor surface the flow cell can be lifted off form the flow cell head. This enables a simple and fast switch between different supply and discharge pipes. Moreover, the end portion of the inner and/or outer pipe can be used as a pipette to take up substances for the investigation on the sensor surface. In one embodiment the flow cell head is pressed against the sensor surface to seal the flow cell system from the outside.

On one hand the flow cell system (i.e., the two coaxial pipes) are sealed on the bottom of the flow cell by a press fit, forming a closed flow cell. On the other hand, the flow cell system can be removed (e.g., by a roboter) in order to act as the pipette tip. Finally, the second end portion of the inner pipe can be shaped individually in order to create specific flow conditions close to the bottom of the flow cell, which meet the specific needs of various applications.

In a further advantageous embodiment, a glass fibre is guided along the inner wall of the inner pipe and a fibre end is spaced apart from the sensor surface. The fibre end may be provided with an optical system for coupling light into the fibre. The glass fibre is used to guide light from or to the sensor surface and to provide the possibility to carry out optical measurements. The glass fibre can be introduce in various ways into the flow cell system, but it is important that the fibre end points into the direction of the sensor surface.

The end portion of the inner pipe defines an end, which is of linear shape and parallel to the sensor surface. In case of other shapes of the end portion of the inner pipe the type of flow can easily be influenced. The shape can be curved as well.

### BRIEF DESCRIPTION OF THE DRAWINGS

The various aspects and embodiments of the invention are described with respect to accompanying drawings. In the drawing:

FIG. 1 shows a sectional view of a flow cell along the axis of the flow, wherein the flow cell system is in contact with the sensor surface;

FIG. 2 shows a plan view of the flow cell system;

FIG. 3 shows a detailed view of the first end portion and the second end portion of the outer pipe and the inner pipe;

FIG. 4a shows an embodiment of the tip design of the inner pipe of the flow cell system;

FIG. 4b shows an embodiment of the tip design of the inner pipe of the flow cell system;

FIG. 4c shows an embodiment of the tip design of the inner pipe of the flow cell system;

FIG. 4d shows an embodiment of the tip design of the inner pipe of the flow cell system; and

FIG. 4e shows an embodiment of the tip design of the inner pipe of the flow cell system.

### DETAILED DESCRIPTION OF THE INVENTION

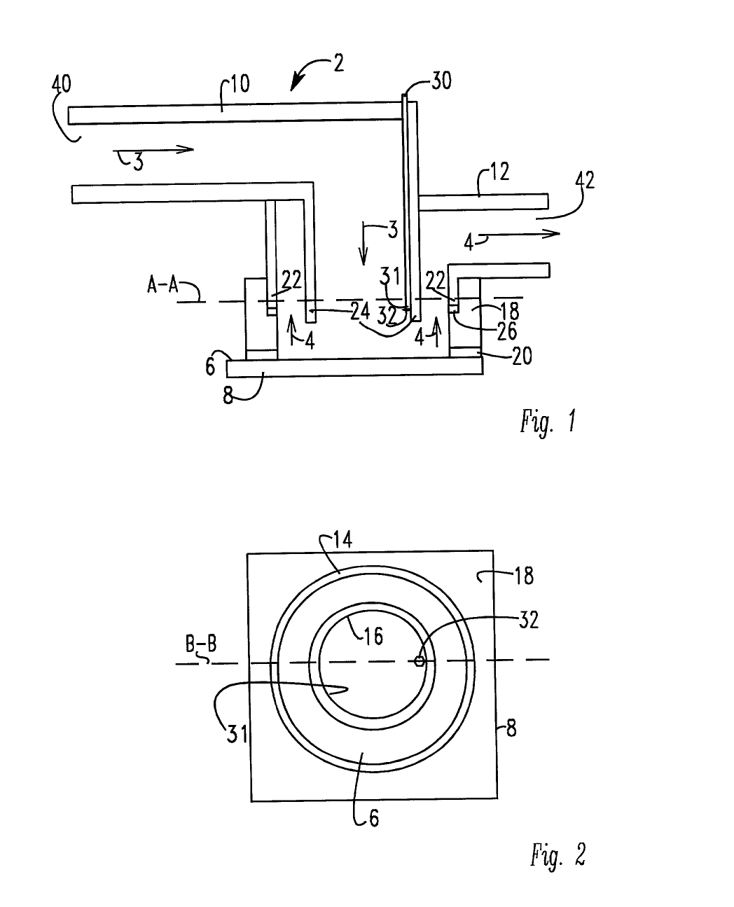

SPR measurement is well known in the art so that it is not necessary in this context to go into more detail. FIG. 1 shows a sectional view of a flow cell system 2 along a line B-B as indicated in FIG. 2. The flow cell system 2 is attached to a surface 6 of a sensor chip 8 that forms the bottom of the flow cell. The substances (for example gases or liquids) to be investigated are transported to the sensor surface 6 via a supply pipe 10. The substances from the sensor surface 6 are transported off by a discharge pipe 12. In FIG. 2, a plan view, taken along line A-A in FIG. 1, of the flow cell system 2 is shown. In an area close to the surface of the sensor surface 6 the supply pipe 10 and the discharge pipe 12 are arranged coaxially. An outer pipe 14 is defined by the discharge pipe 12. An inner pipe 16 is defined by the supply pipe 10. The inner pipe 16 is separated from the outer pipe 14 by a distance rₐ and the inner pipe 16 has an inner radius r_{0.}

The flow cell system comprises a flow cell head 18 which is attached to the sensor surface 6. In one embodiment, a sealing 20 is provided between the sensor surface 6 and the flow cell head 18. Depending on the material of the flow cell head 18, the sealing 20 can be omitted as well. This is possible if the material of the flow cell head or the applied mechanical pressure provides enough sealing between the sensor surface 6 and the flow cell head 18.

The outer pipe 14 and the inner pipe 16 end in a tip defining a first end portion 22 and an second end portion 24. Especially, the second end portion 24 is arranged adjacent to the sensor surface 6, and the tip and the flow cell head 18 are hold together by a press fit. The flow cell head 18 has a step 26 formed which provides a stop for the first end portion 22 of the outer pipe 14. As mentioned already above, a sealing 20 may be provided as well between the step 26 and the end portion 22 of the outer pipe.

As shown in FIG. 1 and FIG. 2 a glass fibre 30 is guided along the inner wall 31 of the inner pipe 16. The inner pipe 16 may be arranged displaceable with respect to the outer pipe 14. The glass fibre 30 defines a fibre end 31, which is provided with an optic 32 for coupling light into the glass fibre 30. The sealing between the flow cell head 18 and the outer pipe 14 is achieved by a press fit or by the additional sealing 20 on the step 26 of the flow cell head 18. In the embodiment as shown in FIG. 1 the inner pipe 16 provides a flow as indicated by the arrows 3. The flow hits the sensor surface 6 and the space defined by the distance between the outer pipe 14 and the inner pipe 16. The flow from the sensor surface 6 is indicated by the arrows 4. The supply pipe 10 defines an inlet 40 and the discharge pipe 12 defines an outlet 42. A pump (not shown) might be attached to the inlet 40 as well as to the outlet 42, which provides the possibility to reverse the flow of the substances.

In case the substances to be investigated are aggressive, all the material of the flow cell system 2 is made of stainless steel. For biochemical applications the material of the flow cell system 2 is biochemically inert, for example PEEK, of Teflon®.

In an additional embodiment, the second end portion 24 of the inner pipe 16 acts as a pipette tip, which takes up a substance from a reservoir. Then, the flow cell system 2 is moved back to the flow cell head 18 and pressed into it. The substance in the supply pipe 10 is sent to the sensor surface 6 for investigation.

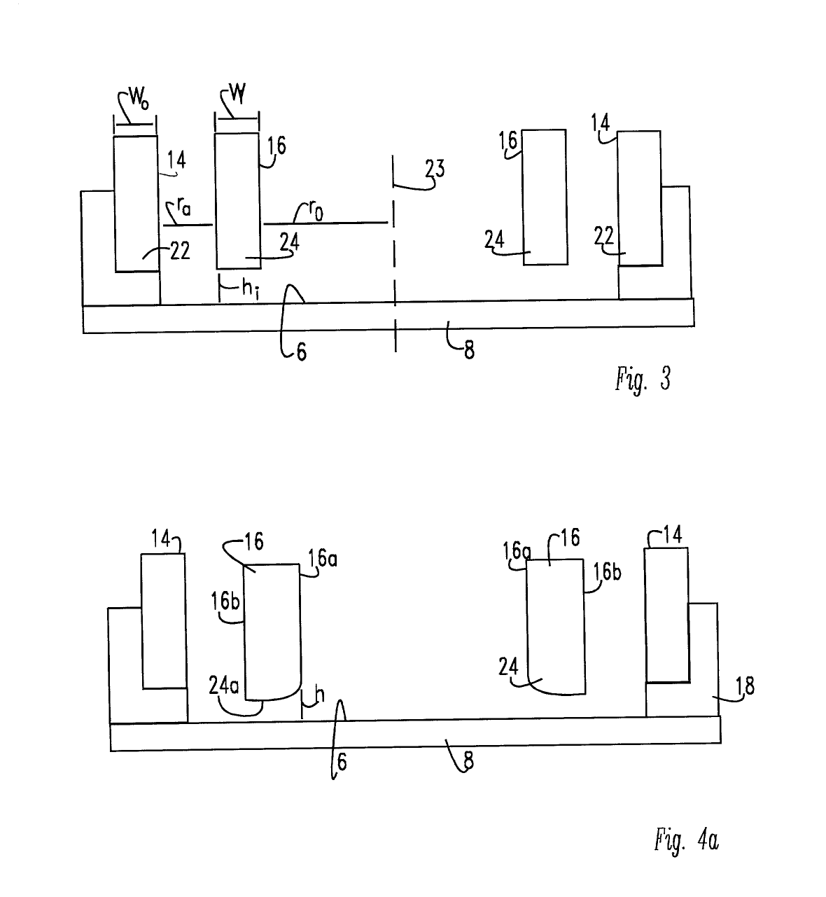

FIG. 3 shows a detailed view of the first end portion 22 and the second end portion 24 of the outer pipe 14 and the inner pipe 16. The outer pipe 14 is separated from the inner pipe 16 by a distance rₐ. The outer pipe 14 has a wall thickness W₀and the inner pipe 16 has a wall thickness Wᵢ. The inner pipe 16 and the outer pipe 14 are arranged around a common centre 23, which is marked in FIG. 3 with a dashed line. The inner pipe 16 has an inner radius r₀. The second end portion 24 of the inner pipe 16 is spaced apart a distance hᵢ from the sensor surface 6. In FIG. 3 the flow cell head 18 is attached to the sensor surface 6 without a sealing. As well no sealing is provided between the step 26 of the flow cell head 18 and the first end portion 22 of the outer pipe 14.

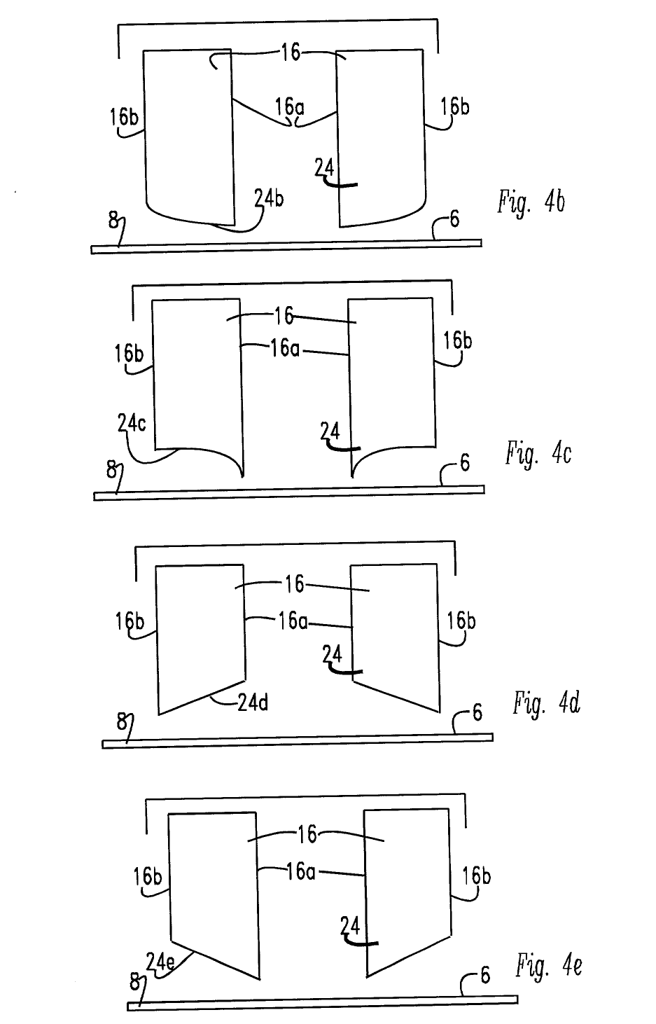

FIG. 4a shows an embodiment of the design of the second end portion 24 of the inner pipe 16. The inner pipe 16 defines an inner wall 16a and an outer wall 16b and both are separated by the wall thickness W_{i.} The second end portion 24 of the inner pipe 16 has a curved shape and is defined in the projection by a curve 24a connecting the inner wall 16a with the outer wall 16b. The inner wall 16a is spaced from the sensor surface 6 by a distance h, which is marked in FIG. 4a by a double arrow. The outer wall 16b is closer to the sensor surface 6. The shape of the curve 24a is exponential. As shown in the other embodiments, the shape of the curve can be of different forms, for example exponential, hyperbolic or linear.

FIG. 4b shows another embodiment of the design of the second end portion 24 of the inner pipe 16. The second end portion 24 of the inner pipe 16 has a curved shape as well and is defined in the projection by a curve 24b connecting the inner wall 16a with the outer wall 16b. The outer wall 16b is more distant to the sensor surface 6 than the inner wall 16a. The shape of the curve 24b is exponential.

FIG. 4c shows another embodiment of the design of the second end portion 24 of the inner pipe 16. The second end portion 24 of the inner pipe 16 has a curved shape as well and is defined in the projection by a curve 24c connecting the inner wall 16a with the outer wall 16b. The outer wall 16b is more distant to the sensor surface 6 than the inner wall 16a. The shape of the curve 24c is hyperbolic.

FIG. 4d shows another embodiment of the design of the second end portion 24 of the inner pipe 16. The second end portion 24 of the inner pipe 16 has a linear shape and is defined in the projection by a line 24d connecting the inner wall 16a with the outer wall 16b. The outer wall 16b is closer to the sensor surface 6 than the inner wall 16a. The shape of the curve 24d is linear.

FIG. 4e shows another embodiment of the design of the second end portion 24 of the inner pipe 16. The second end portion 24 of the inner pipe 16 has a linear shape and is defined in the projection by a line 24e connecting the inner wall 16a with the outer wall 16b. The outer wall 16b is more distant to the sensor surface 6 than the inner wall 16a. The shape of the curve 24e is linear.

What is claimed is:

1. A flow cell system comprising:
an inner pipe defining a supply pipe with an end portion;
an outer pipe surrounding the inner pipe at a selected distance and defining a discharge pipe with an end portion;
a flow cell head being attached to a sensor surface and
a tip defined by the end portion of the inner pipe and the outer pipe, wherein the tip is arranged adjacent to the sensor surface, and the tip and the flow cell head are hold together by a press fit.

2. The flow cell system as defined in claim 1, wherein a sensor is provided and the flow cell head is pressed against the sensor surface to seal the flow cell system from the outside.

3. The flow cell system as defined in claim 2, wherein an extra sealing is provided between the flow cell head and the sensor surface.

4. The flow cell system as defined in claim 1, wherein a step is formed on the flow cell head and the end portion of the outer pipe is pressed in contact with the step and thereby seals the flow cell from the outside.

5. The flow cell system as defined in claim 4 wherein an extra sealing is provided between the step of the flow cell head and the end portion of the outer pipe.

6. The flow cell system as defined in claim 1, wherein the end portion of the inner pipe and the end portion of the outer pipe are arranged around common center and the overall diameter is between 10μm an 10 m.

7. The flow cell system as defined in claim 6, wherein the overall diameter is between 0,1 mm and 10 mm.

8. The flow cell system as defined in claim 1, wherein a glass fibre is provided and an end of the glass fibre points to the sensor surface, and the end of the glass fibre is attached to an optic.

9. The flow cell system as defined in claim 8, wherein the glass fibre is used for guiding light from or to the sensor surface and carry out absorption or fluorescent measurements.

10. The flow cell system as defined in claim 1, wherein the end portion of the inner pipe defines an end which is of linear shape a parallel to the sensor surface.

11. The flow cell system as defined in claim 1, wherein the end portion of the inner pipe defines an end which is of linear shape and inclined with respect to the sensor surface.

12. The flow cell system as defined in claim 1 wherein the end portion of the inner pipe defines an end which is of a curved shape and the shape of the curve is exponential of hyperbolic.

13. A flow cell comprising:
a flow cell head;
an inner pipe defining a supply pipe; and
an outer pipe defining a discharge pipe, wherein the inner pipe defines an end portion, the outer pipe defines an end portion and the inner and the outer pipe are arranged concentrically in the area of their end portions, and the end portion of the outer pipe is hold by a press fit in the flow cell head.

14. The flow cell as defined in claim 13, wherein a step is formed on the flow cell head and the end portion of the outer pipe is pressed in contact with the step and thereby seal the flow cell from the outside.

15. The flow cell as defined in claim 14, wherein an additional sealing is provided on the step of the flow cell head and the end portion of the outer pipe is pressed in contact with the sealing.

16. The flow cell as defined in claim 13 wherein the flow cell head is in contact with a sensor surface of a sensor and the contact seals the flow cell from the outside.

17. The flow cell as defined in claim 13 wherein the end portion of the inner pipe and the end portion of the outer pipe are arranged around common center and the overall diameter is between 10μm an 10 m.

18. The flow cell as defined in claim 17 wherein the overall diameter is between 0,1 mm and 10 mm.

19. The flow cell as defined in claim 13, wherein a glass fibre is provided and an end of the glass fibre points to the sensor surface, and the end of the glass fibre is attached to an optic.

20. The flow cell as defined in claim 19 wherein the glass fibre is used for guiding light from or to the sensor surface and carry out absorption or fluorescent measurements.

21. The flow cell as defined in claim 13 wherein the end portion of the inner pipe defines an end which is of linear shape a parallel to the sensor surface.

22. The flow cell as defined in claim 13 wherein the end portion inner pipe defines an end which is of linear shape and inclined with respect to the sensor surface.

23. The flow cell as defined in claim 13 wherein the end portion of the inner pipe defines an end which is of a curved shape and the shape of the curve is exponential of hyperbolic.
